(19) United States
(12) Patent Application Publication
(10) Pub. No.: US 2021/0020905 A1
(43) Pub. Date: Jan. 21, 2021

(54) LITHIUM ION BATTERY SILICON CARBON ELECTRODE MATERIAL AND PREPARATION METHOD THEREOF

(71) Applicant: GIGA SOLAR MATERIALS CORP., Hsinchu (TW)

(72) Inventors: Meng-Ting Tsai, Hsinchu (TW); Jian-Shiou Huang, Hsinchu (TW); Chun-Wei Hsu, Hsinchu (TW); Wen-Chun Yen, Hsinchu (TW)

(73) Assignee: GIGA SOLAR MATERIALS CORP., Hsinchu (TW)

(21) Appl. No.: 16/930,283

(22) Filed: Jul. 15, 2020

Related U.S. Application Data
(60) Provisional application No. 62/874,961, filed on Jul. 16, 2019.

(30) Foreign Application Priority Data
Jun. 22, 2020 (TW) 109121037

(51) Int. Cl. H01M 4/133; H01M 4/1393; H01M 4/134; H01M 4/1395; H01M 4/36; H01M 10/0525

(52) U.S. Cl. CPC H01M 4/133; H01M 4/1393; H01M 4/134; H01M 2004/021; H01M 4/366; H01M 10/0525; H01M 4/1395

(57) ABSTRACT

A lithium ion battery silicon carbon electrode material and a preparation method thereof are provided. The lithium ion battery silicon carbon electrode material includes a graphite particle and a resin carbon layer. The resin carbon layer is smoothly coated on a surface of the graphite particle, and silicon or a silicon compound and a conductive material are coated in the resin carbon layer.

This application claims the priority benefit of U.S. provisional application Ser. No. 62/874,961, filed on Jul. 16, 2019, and Taiwan application serial no. 109121037, filed on Jun. 22, 2020. The entirety of each of the above-mentioned patent applications is hereby incorporated by reference herein and made a part of this specification.

### BACKGROUND OF THE INVENTION

### 1. Field of the Invention

The invention relates to an electrode material and a preparation method thereof, particularly to a lithium ion battery silicon carbon electrode material and a preparation method thereof.

### 2. Description of Related Art

In the existing lithium battery industry, an anode is mainly made of a graphite material, such as natural graphite, artificial graphite or the like. Graphite has the essential characteristic of low electrochemical potential, and its layered structure also happens to be suitable for the migration and storage of lithium ions. In addition, a volume change rate of graphite during a charge and discharge process is small, so the graphite has become a mainstream material of the current commercial lithium battery anode. However, in recent years, due to the light weight and long-term output of 3C vehicles and electric vehicles, the requirements for energy density of a battery have also rapidly increased. The graphite with a theoretical specific capacitance of only 372 mAhg-l has gradually failed to meet the needs of future energy storage batteries. In contrast, lithium silicon compounds with 9 to 11 times the specific capacitance of the graphite have become the mainstream of technological development of high-energy-density anode materials.

However, due to the characteristic of high storage capacity of silicon for lithium ions, the silicon lattice is forced to produce a volume swelling of about 400% when being alloyed with lithium ions. This high volume swelling rate will cause the silicon to be detached from each other, causing the electrode to peel off from the current collector after powdering. In addition, the contact area between the silicon and the electrode becomes smaller and the distance becomes longer, the electric field may not effectively act on the electrode, and therefore, the lithium ions and electrons may not be effectively used, causing a rapid decline in the number of cycles of the battery and a significant decrease in battery life. On the other hand, the intrinsic silicon itself is poor in conductivity, causing the disadvantages of high internal resistance and slow heat dissipation and also greatly affecting the performance of the battery. Based on the above, how to prevent the silicon electrode from peeling off and increase the electron conductivity of the silicon electrode to increase the cycle life of the silicon anode is the most priority issue that must be overcome in the current silicon anode commercialization.

### SUMMARY OF THE INVENTION

The invention provides a lithium ion battery silicon carbon electrode material and a preparation method thereof to increase a service life of a lithium battery silicon carbon anode material.

The lithium ion battery silicon carbon electrode material of the invention includes a graphite particle and a resin carbon layer. The resin carbon layer is smoothly coated on a surface of the graphite particle. Silicon or a silicon compound and a conductive material are coated in the resin carbon layer.

In an embodiment of the invention, an average thickness of the resin carbon layer is 5 nm to 500 nm, an average thickness change rate is 12.34%, and a thickness change standard deviation is 5.16.

In an embodiment of the invention, a particle size of the graphite particle is 5 μm to 30 μm.

In an embodiment of the invention, the conductive material includes metal nanoparticles, conductive carbon black, acetylene black, graphene, carbon nanotubes or flake graphite.

The preparation method of the lithium ion battery silicon carbon electrode material of the invention includes steps as follows. Firstly, mixing a graphite particle, silicon or a silicon compound and a conductive material, adding resin, performing stirring and mixing, and adding a resin reactant during or after curing process. Then, performing carbonization such that a resin carbon layer is smoothly coated on a surface of the graphite particle and the silicon or the silicon compound and the conductive material are coated in the resin carbon layer.

In an embodiment of the invention, relative to 100 wt % of the graphite particle, an addition amount of the silicon or the silicon compound and the conductive material is 5 wt % to 20 wt %.

In an embodiment of the invention, relative to 100 wt % of the graphite particle, an addition amount of the resin is 10 wt % to 50 wt %.

In an embodiment of the invention, relative to 100 wt % of the graphite particle, an addition amount of the resin reactant is 5 wt % to 15 wt %.

In an embodiment of the invention, the resin includes phenol-formaldehyde resin, urea resin, melamine resin, unsaturated polyester resin, epoxy resin, silicone resin, polyurethane, polyethylene, polypropylene, polystyrene, ABS resin, polyvinyl chloride, acrylic resin, nylon POM, polycarbonate, cellulose resin or polyethylene terephthalate.

In an embodiment of the invention, the conductive material includes metal nanoparticles, conductive carbon black, acetylene black, graphene, carbon nanotubes or flake graphite.

In an embodiment of the invention, the resin reactant includes sucrose, glucose, cellulose, chitin, phytic acid or a combination thereof.

In an embodiment of the invention, the carbonization is performed in an inert gas at 600° C. to 1000° C.

Based on the above, the invention provides the lithium ion battery silicon carbon electrode material and the preparation method thereof. By additionally adding the resin reactant, the resin carbon layer is smoothly coated on the surface of the graphite particle, and the silicon or the silicon compound and the conductive material are coated in the resin carbon layer without being exposed. Thus, disadvantages of high first-cycle irreversible rate and high BET in hard carbon are improved by chemical modification; meanwhile, an advantage of rigid structure in the hard carbon is maintained, and thereby effectively improving life performance of the lithium ion battery silicon carbon anode material.

### BRIEF DESCRIPTION OF THE DRAWINGS

FIG. 1 is a schematic diagram of a lithium ion battery silicon carbon electrode material according to an embodiment of the invention.

### DESCRIPTION OF THE EMBODIMENTS

In this specification, a range represented by “from a numerical value to another numerical value” is a summary representation that avoids enumerating all numerical values in this range one by one. Therefore, a specific numerical range recorded covers a smaller numerical range defined by a numerical value and another numerical value within this numerical range, as if the numerical values and the smaller numerical range are explicitly written in the specification.

The following makes detailed description by listing embodiments and with reference to accompanying drawings, but the provided embodiments are not intended to limit the scope covered by the invention. In addition, the drawings are drawn only for the purpose of description, and are not drawn according to original sizes.

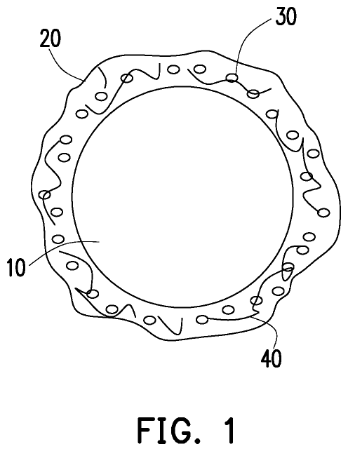

FIG. 1 is a schematic diagram of a lithium ion battery silicon carbon electrode material according to an embodiment of the invention.

Referring to FIG. 1, the lithium ion battery silicon carbon electrode material of the invention includes a graphite particle 10 and a resin carbon layer 20. The resin carbon layer 20 is smoothly coated on a surface of the graphite particle 10, and silicon or a silicon compound (for example, nano silicon 30 in FIG. 1, but the invention is not limited thereto) and a conductive material 40 are coated in the resin carbon layer 20 without being exposed. In the present embodiment, a particle size of the graphite particle is, for example, 5 μm to 30 μm, an average thickness of the resin carbon layer 20 is, for example, 5 nm to 500 nm, an average thickness change rate is 12.34%, a thickness change standard deviation is 5.16, and therefore, it can be seen that the resin carbon layer 20 is smoothly coated on the graphite particle 10 and has a uniform thickness. In more detail, the average thickness, the average thickness change rate and the thickness change standard deviation of the resin carbon layer 20 are obtained by performing image processing through a scanning electron microscope (SEM). The average thickness change rate is defined as follows: by taking the minimum value obtained by image processing as a base value, each value is subtracted from the base value, and an average is taken. The conductive material may include metal nanoparticles, conductive carbon black, acetylene black, graphene, carbon nanotubes or flake graphite. The metal nanoparticles are composed of aluminum, silver or copper, but the invention is not limited thereto.

The invention also provides a preparation method of a lithium ion battery silicon carbon electrode material for manufacturing the lithium ion battery silicon carbon electrode material of FIG. 1. The preparation method includes steps as follows. Firstly, a graphite particle, silicon or a silicon compound and a conductive material are uniformly mixed, resin is added, stirring and mixing are performed, and a resin reactant is added during or after curing process. In the present embodiment, relative to 100 wt % of the graphite particle, an addition amount of the silicon or the silicon compound and the conductive material is, for example, 5 wt % to 20 wt %, an addition amount of the resin is, for example, 10 wt % to 50 wt %, and an addition amount of the resin reactant is, for example, 5 wt % to 15 wt %. In more detail, the resin may include phenol-formaldehyde resin, urea resin, melamine resin, unsaturated polyester resin, epoxy resin, silicone resin, polyurethane, polyethylene, polypropylene, polystyrene, ABS resin, polyvinyl chloride, acrylic resin, nylon POM, polycarbonate, cellulose resin or polyethylene terephthalate. The conductive material may include metal nanoparticles, conductive carbon black, acetylene black, graphene, carbon nanotubes or flake graphite. The resin reactant may include sucrose, glucose, cellulose, chitin, phytic acid or a combination thereof. Then, carbonization is performed, for example, in an inert gas at 600° C. to 1000° C. such that the resin carbon layer 20 is smoothly coated on a surface of the graphite particle 10 and the silicon or the silicon compound (for example, nano silicon 30 in FIG. 1, but the invention is not limited thereto) and the conductive material 40 are coated in the resin carbon layer 20 without being exposed.

In the conventional technology, a resin composite silicon carbon material that is not processed by the preparation method of the invention may not form a smoothly coated resin carbon layer on the surface of the graphite particle, the silicon or the silicon compound and the conductive material may not be coated in the resin carbon layer without being exposed, but form an angular unsmooth layer on the surface of the graphite particle, and the silicon or the silicon compound and the conductive material are easily exposed. In contrast, according to the preparation method of the lithium ion battery silicon carbon electrode material provided by the invention, since the resin reactant is added for chemical modification, the smoothly coated resin carbon layer can be formed on the surface of the graphite particle, and the silicon or the silicon compound and the conductive material are coated in the resin carbon layer without being exposed. In more detail, by using the preparation method of the lithium ion battery silicon carbon electrode material of the invention, a BET of the prepared lithium ion battery silicon carbon electrode material may be reduced from 17.78 m²/g to 2.99 m²/g, a first-cycle irreversible rate may be reduced from 20% to 10% to 14%, and a capacitance for the first cycle may reach 570 mAh/g. Therefore, the service life of the lithium ion battery silicon carbon electrode material may be effectively improved.

In the present embodiment, the BET is measured by using Micromeritics ASAP2020. A sample is firstly dehumidified at 350° C. for 1 hour, and then a specific surface area value (m²/g) of the powder is calculated by using a nitrogen adsorption-desorption curve. The first-cycle irreversible rate is measured by using Arbin LBT20084 (a capacity measured under the following conditions, first-cycle discharge capacity/first-cycle charge capacity is first-cycle efficiency):

First-cycle charge and discharge

Charging at 0.1 C to 0.01 V

Discharging at 0.1 C to 2.0 V

Cyclic charge and discharge

Charging at 1 C to 0.01 V

Discharging at 1 C to 2.0 V

Hereinafter, the lithium ion battery silicon carbon electrode material and the preparation method thereof according to the above embodiment will be described in detail through an experimental example. However, the following experimental example is not intended to limit the invention.

### Experimental Example

In order to prove that the preparation method of the silicon carbon electrode material of the invention can effectively improve the service life of the lithium ion battery silicon carbon electrode material, the following experimental example is made specifically.

15 g of silicon and flake graphite were added to 100 g of graphite. After stirring, 30 g of epoxy resin (epoxy) and 5 g of glucose were added and further stirred. After curing process, carbonization was performed in an inert gas at 850° C. to prepare the lithium ion battery silicon carbon electrode material of the invention. The material was made into a button battery in a generally conventional manner, according to measurement results, the BET may be reduced from 17.78 m²/g to 2.99 m²/g, the first-cycle irreversible rate may be reduced from 20% to 10% to 14%, and the capacitance for the first cycle may reach 570 mAh/g.

Based on the above, the invention provides the lithium ion battery silicon carbon electrode material and the preparation method thereof. By additionally adding the resin reactant, the resin carbon layer is smoothly coated on the surface of the graphite particle, and the silicon or the silicon compound and the conductive material are coated in the resin carbon layer without being exposed. Thus, the disadvantages of high first-cycle irreversible rate and high BET in hard carbon are improved by chemical modification. The BET may be reduced from 17.78 m²/g to 2.99 m²/g, the first-cycle irreversible rate may be reduced from 20% to 10% to 14%, and the capacitance for the first cycle may reach 570 mAh/g; meanwhile, the advantage of rigid structure in the hard carbon is maintained, and thereby effectively improving the life performance of the lithium ion battery silicon carbon anode material.

What is claimed is:

1. A lithium ion battery silicon carbon electrode material, comprising:
a graphite particle; and
a resin carbon layer, smoothly coated on a surface of the graphite particle, wherein silicon or a silicon compound and a conductive material are coated in the resin carbon layer.

2. The lithium ion battery silicon carbon electrode material according to claim 1, wherein an average thickness of the resin carbon layer is 5 nm to 500 nm, an average thickness change rate is 11% to 17%, and a thickness change standard deviation is 4 to 6.

3. The lithium ion battery silicon carbon electrode material according to claim 1, wherein a particle size of the graphite particle is 5 μm to 30 μm.

4. The lithium ion battery silicon carbon electrode material according to claim 1, wherein the conductive material comprises metal nanoparticles, conductive carbon black, acetylene black, graphene, carbon nanotubes or flake graphite.

5. A preparation method of a lithium ion battery silicon carbon electrode material, comprising:
mixing a graphite particle, silicon or a silicon compound and a conductive material, adding resin, performing stirring and mixing, and adding a resin reactant during or after curing process; and
performing carbonization, such that a resin carbon layer is smoothly coated on a surface of the graphite particle, and the silicon or the silicon compound and the conductive material are coated in the resin carbon layer.

6. The preparation method according to claim 5, wherein relative to 100 wt % of the graphite particle, an addition amount of the silicon or the silicon compound and the conductive material is 5 wt % to 20 wt %.

7. The preparation method according to claim 5, wherein relative to 100 wt % of the graphite particle, an addition amount of the resin is 10 wt % to 50 wt %.

8. The preparation method according to claim 5, wherein relative to 100 wt % of the graphite particle, an addition amount of the resin reactant is 5 wt % to 15 wt %.

9. The preparation method according to claim 5, wherein the resin comprises phenol-formaldehyde resin, urea resin, melamine resin, unsaturated polyester resin, epoxy resin, silicone resin, polyurethane, polyethylene, polypropylene, polystyrene, ABS resin, polyvinyl chloride, acrylic resin, nylon POM, polycarbonate, cellulose resin or polyethylene terephthalate.

10. The preparation method according to claim 5, wherein the conductive material comprises metal nanoparticles, conductive carbon black, acetylene black, graphene, carbon nanotubes or flake graphite.

11. The preparation method according to claim 5, wherein the resin reactant comprises sucrose, glucose, cellulose, chitin, phytic acid or a combination thereof.

12. The preparation method according to claim 5, wherein the carbonization is performed in an inert gas at 600° C. to 1000° C.
